(19) United States
(12) Patent Application Publication
(10) Pub. No.: US 2026/0366875 A1
(43) Pub. Date: Nov. 19, 2026

(54) RADAR-POSITIONING PROCESS AND RELATED ASPECTS

(71) Applicant: Kongsberg Maritime AS, Kongsberg (NO)

(72) Inventors: Kaj-Robin WESLIEN, Kongsberg (NO); Jaroslaw WRZESIEN, Hvittingfoss (MO)

(21) Appl. No.: 19/158,818

(22) PCT Filed: Feb. 16, 2024
(86) PCT No.: PCT/NO2024/050043

§ 371 Date: Aug. 21, 2025

(30) Foreign Application Priority Data
Feb. 23, 2023 (NO) 2030178

(51) Int. Cl. G01C 21/20; G01S 13/42; G01S 13/89

(52) U.S. Cl. CPC G01C 21/203; G01S 13/426; G01S 13/89

(57) ABSTRACT

A computer-implemented method for finding a geographic location of a vessel using radar comprises acquiring at least two time-sequential radar scan images, processing the radar images at least by compensating for motion of the vessel between radar scan images and suppressing radar echoes from moving objects, deriving a combined radar scan image from the processed radar scan images, inputting a vessel position, matching, for a plurality of estimated vessel positions in a search area including the estimated at least one vessel position, the combined radar scan image to one or more closest navigation chart coastline locations to each estimated vessel position, and determining the geographic location of the vessel based on the estimated vessel position resulting in the best match of the combined radar scan image to the one or more navigation chart coastlines locations.

The present disclosure relates to locating a vessel using radar, for example, to using automatic radar-positioning to determine a vessel's location and to related aspects.

In particular, but not exclusively, the disclosure relates to a method for automatically radar-positioning a vessel using a radar system which is able to assess its own accuracy, and to a method of automatically assessing the accuracy of vessel location determined using the method for automatically radar-positioning the vessel. The vessel may be an autonomous or remotely controlled vessel or be another type of vessel with an unmanned bridge in some embodiments. The method may be performed by the vessel and references to vessel herein include references to an ego vessel autonomously performing the disclosed technology unless the context expressly excludes this.

### BACKGROUND

Whilst regulations may be imposed on large vessels, including, by way of example but not limited to, large navy vessels such as air-craft carriers and destroyers and the like, as well as large merchant vessels such as oil and gas tankers, grain-carrying ships, shipping container transporting vessels and large cruise ships and larger fishing crawlers and like which are all required to localize themselves using all available means, smaller vessels also require localization for navigation purposes.

Localization of such vessels may need to be done to varying degrees of accuracy depending on the vessels environment. For example, when manoeuvring into a port or docking, localization to sub-meter distances may be required, whereas in international waters, for example, and 15 nautical miles from any nearby object or land mass localization may only be required to within a couple of hundred meters or so. Some regions may also impose regulations for specific levels of localization to be met, for example, how accurately a vessel's absolute or map based position is determined within a certain degree of latitude/longitude and/or with another specified form of accuracy, e.g. within +/−a number of meters.

Some regulations impose a requirement for all available means to be used to localize a vessel. All available means includes navigation radar(s) for example, which is required by the International Maritime Organization (IMO) for all larger commercial and civilian vessels and similar regulations may be imposed for navy vessels. These requirements are added because Global Navigation Satellite Systems, GNSS, such as BeiDou Navigation Satellite System (BDS), Galileo, Global Positioning System (GPS), Globalnaya Navigazionnaya Sputnikovaya Sistema (GLONASS), Indian Regional Navigation Satellite System (IRNSS)/Navigation Indian Constellation (NavIC), are not reliable enough for safe navigation in all waters and under all conditions. In addition, navy vessels, being resilient against GNSS jamming and spoofing is a requirement, and manual procedures for safe navigation is practiced extensively.

The development of automated, for example, autonomously navigated and/or operated vessels including vessels which are remote controlled, might require automated localization with increased accuracy and reliability than may be required for manned and human navigated vessels.

Existing navigation systems may use radar-positioning rely on human interpretation for confirming a vessel location. FIG. 1 shows an example of a radar image super-imposed on an electronic chart, in an electronic chart display and information system, ECDIS. An ECDIS chart complies with IMO Regulation V/19 & V/27 of SOLAS convention as amended, by displaying selected information from a System Electronic Navigational Chart (SENC). ECDIS equipment complying with SOLAS requirements can be used as an alternative to paper charts. Whilst a radar image may be presented side-by-side with an electronic or even a paper chart, this may not be practical or safe in all situations. For example, a vessel navigator or radar operative or other crew member must then assesses similarities of radar features to those of the comparison chart to determine if the vessel appears to have been correctly located at a given GNSS position. This visual assessment requires constant attention from a focused human. Depending on the selected range-scale of the radar picture the accuracy achieved varies a lot. Other disadvantages include, as comparing radar against chart removes focus from the task of collision avoidance, a higher inherent risk of collision occurring. This risk increases if the radar image gets cluttered with chart information if the chart is overlaid or underlaid with radar as it may require even more focus from the crew member performing the visual assessment.

Another method, which is more accurate, involves manually tracking or tracking by automatic means smaller objects in the water which have a known geographic position, like Aids to Navigation (ATONs). An ATON is any device external to a vessel or aircraft specifically intended to assist navigators in determining their position or safe course, or to warn them of dangers or obstructions to navigation.

Some radar systems are capable of back-tracking their own ship's position by designating a tracked ATON or other type of tracked object as a vessel location reference target. A vessel's ego-position can then be determined by using an on-board radar system to track radar echoes of a plurality of tracked known objects, assigning a known position to each tracked objects, for example, from where it is shown on chart data, and then, the position of the vessel hosting the radar system can be determined based on the range and bearing to each object's known position.

This other method of tracking reference targets is more accurate, but requires manual intervention every time a reference target gets out of the line-of-sight, for example, as this would generate a target lost alert which would indicate the radar-positioning is lost.

Such known methods are accordingly labour intensive as a navigator is required to constantly prepare new reference targets along with their position from the ENC charts, as well as acknowledging the alerts or manually removing the objects that will soon disappear as a vessel moves along its course. Because of the manual labour involved, this second method, although a more accurate method radar-positioning a vessel, is rarely used by vessel navigators, with increased grounding hazard as a consequence.

### SUMMARY STATEMENTS OF INVENTION

The disclosed technology relates to a system and method for an ego vessel to automatically determine its location using radar-positioning. In some embodiments, an estimated quality of the radar-positioned location is also provided along with the ego vessel location.

The disclosed technology is limited to environments where an ego vessel is within range of a radar reflecting object. This may limit use of the disclosed technology, for example, to coastal areas, and/or for example, where the ego vessel is located within 100 nautical miles, NM, from a shoreline (or less, as this will depend on the maximum range of the ego vessel's navigational radar system). A conventional navigational radar system may be used without external position input once the positioning system has been initialised with an approximate known position. The initial approximate location may be provided manually or using GNSS. Once initialized, the proposed radar-positioning technique does not rely on external reference position systems such as GNSS and uses radar and heading sensor information, which, for example, can be obtained from a compass.

According to a first aspect of the disclosed technology, A computer-implemented method for finding a geographic location of a vessel using radar comprises acquiring at least two time-sequential radar scan images, processing the radar images at least by compensating for motion of the vessel between radar scan images and suppressing radar echoes from moving objects, deriving a combined radar scan image from the processed radar scan images, inputting a vessel position for the combined radar scan; matching, for a plurality of estimated vessel positions in a search area including the input vessel position, the combined radar scan image to one or more closest navigation chart coastline locations to each of the plurality of estimated vessel positions, and determining the geographic location of the vessel based on the estimated vessel position resulting in the best match of the combined radar scan image to the one or more navigation chart coastlines locations.

The disclosed embodiments of the method of the first aspect do not require any pre-processing of the radar data which involves detection or thresholding of what is signal, noise or clutter. Instead the method of the first aspect and its described embodiments find the most likely match between chart and radar data. In this way, as long as there are land or known objects in the water visible to a vessel's radar system, there is a good likelihood that the vessel's position can be correctly located using its radar system. Even if there are weak radar echoes hidden in clutter, for example, from ocean waves and rain clouds, the method of vessel positioning may still be reliably used with scan-to-scan signal enhancement.

In some embodiments, the closest coastline locations to each estimated vessel location are obtained by obtaining coastline chart data based on an initial possible vessel position and determining the locations of coastlines in line of sight of each possible vessel location in the search area from the obtained coastline chart data.

In some embodiments, in each iteration of method 300, the matching comprises projecting of the electronic chart closest coastline location data onto the combined radar scan to find the best fit for all possible vessel locations.

In some embodiments, the best fit is found by finding the possible vessel location in the search area having the highest sum of radial gradients in the amplitude radar echo image data at the expected location of the closest coastline data from that possible vessel position.

In some embodiments, the processing of the radar images (304) results in a smeared representation of one or more or all of moving objects, clutter, noise and interference in the combined radar scan which has a lower radial gradient of echo signal intensity along a line of sight from the vessel.

In some embodiments, the processing further includes one or both of enhancing the signal to noise of the radar echo signal in each motion compensated acquired scan or filtering noise from each motion compensated acquired scan.

In some embodiments, the closest coastline data also comprises other stationary objects shown in the electronic chart data from which a radar scan echo may be generated.

In some embodiments, the coastline may also comprise a coastline in tidal waters, time-of-day and date may be taken into account when obtaining the closest line-of-sight coastline data to a possible vessel location. In some embodiments, coastlines with shallow beaches where the coastline data changes above a threshold over a period of time are excluded from the coastline data set used to match coastlines to radar image features.

In some embodiments, the method further comprises generating vessel speed and course information and using the generated vessel speed and course information to input the estimate starting vessel position in subsequent iterations of the method of any one of the previous claims.

In some embodiments, the method further comprises generating vessel speed and course information and using the generated vessel speed and course information to perform motion compensation in subsequent iterations of the method of any one of the previous claims.

In some embodiments, the method further comprises generating an estimate of the accuracy of the estimated vessel location, the method comprising obtaining chart coverage area data for the estimated vessel location, determining coastline data from the coverage area, determining closest coastline data for the estimated vessel location, obtaining at least one of a radar range accuracy and a bearing accuracy to the locations of the nearest coastlines, combining, over all bearings, the estimated radar range accuracy and bearing accuracy for each of the nearest coastline(s), and outputting a vessel location accuracy indicator.

Another, second, aspect of the disclosed technology comprises a method of estimating the accuracy of vessel location found using a method according to the first aspect or any of its embodiments disclosed herein, the method of accuracy estimation comprising generating an estimate of the accuracy of the estimated vessel location, the method comprising obtaining chart coverage area data for the estimated vessel location, determining coastline data from the coverage area, determining closest coastline data for the estimated vessel location, obtaining at least one of a radar range accuracy and a bearing accuracy to the locations of the nearest coastlines, combining, over all bearings, the estimated radar range accuracy and bearing accuracy for each of the nearest coastline(s), and outputting a vessel location accuracy indicator.

In some embodiments, the vessel location accuracy indicator comprises one or more of an audible or visual value metric of accuracy, and an visual shape outline which is overlaid on an image of a combined radar scan.

Another, third, aspect of the disclosed technology comprises apparatus comprising at least: memory, one or more processors or processing circuitry, and computer code, wherein the computer code is stored in the memory and when loaded and executed by the one or more processor(s) or processing circuitry causes the apparatus to implement a method according to one or both of the first or second aspect or any one of their embodiments disclosed herein.

Another, third, aspect of the disclosed technology comprises computer-readable media comprising computer code, wherein the computer code is configured, when loaded from memory and executed by one or more processor(s) or processing circuitry, to cause an apparatus to implement a method according to one or both of the first or second aspect or any one of their embodiments disclosed herein.

Another, third, aspect of the disclosed technology comprises vessel with an unmanned bridge including an apparatus configured to implement a method according to one or both of the first or second aspect or any one of their embodiments disclosed herein.

In some embodiments, the vessel comprises an autonomous vessel or a remotely controlled vessel.

Embodiments of the disclosed technology accordingly provide an automatic radar positioning system which may increase safety in navigation as it reduces the reliance of electronic navigation systems on GNSS systems. For vessel's equipped with a radar scanner, scans are available 24 hours a day and 7 days a week, allowing a vessel's position to be updated every 1 to 2 seconds using the disclosed methods for finding a radar-positioned vessel location. The radar-positioned vessel location can be used for comparison with a contemporaneous satellite generated GNSS vessel location. If the location found by either system deviates by more than a threshold amount the system can be used to trigger a navigation alert.

The disclosed technology accordingly may be used to reduce the vigilance of navigators, who may not always stay sufficiently focused over an entire shift due to distractions such as other tasks to fulfil when on a bridge, and so may improve vessel safety.

Moreover, in the event of a complete GNSS failure (for example, when jamming, spoofing or if there is another type of system failure), the automatic radar-positioning for a vessel location may be used as a backup service for determining a vessel location and also a ground speed sensor.

In some embodiments, which may include a preferred embodiment, . . . as per dependent claims.

Advantageously, embodiments of the disclosed technology automates the process of radar-positioning in a more reliable and accuracy manner. The proposed methods are robust and work well in both harsh weather conditions and in calm waters.

In some embodiments the pre-processing of the radar data does not involve any detection or thresholding of what is signal, noise or clutter, and instead relies on finding the most likely match between chart and radar data.

Accordingly, as long as land or known objects in the water are visible to the radar range, the automatic radar-positioning system according to the disclosed technology will output the true position. In addition to strong radar echoes, weak radar echoes hidden in the clutter, from ocean waves and rain clouds, may also be used for radar-positioning because of scan-to-scan signal enhancement in a motion-compensated manner which is performed in some embodiments.

As the method is self-aware in the sense that it produces an estimate of the position accuracy for a radar-position, based on the surrounding scene, in other words, the radar visible objects around the vessel, it is also possible to generate alerts should the method provide positions with an accuracy below a desired threshold, which may be a regulated threshold.

### LIST OF ACCOMPANYING FIGURES

Some embodiments of the disclosed technology will now be described with reference to the accompanying drawings which are by way of example only and in which:

FIG. 1 shows an example radar image with chart information;

FIG. 2A shows an example set of time-sequential radar scans which may be used in some example embodiments of the disclosed technology;

FIG. 2B shows an example of how motion compensation may be performed in some example embodiments of the disclosed technology;

FIG. 2C shows an example combined echo intensity image according to in some example embodiments of the disclosed technology;

FIG. 3 shows schematically an example of a method of automatically performing radar-positioning of a vessel according to some embodiments of the disclosed technology;

FIG. 4A shows an example of a coastline from a chart which may be used in some example embodiments of the method shown in FIG. 2;

FIG. 4B shows an example of how the coastline of FIG. 4A may be moved relative to the radar image in some example embodiments of the method shown in FIG. 2;

FIGS. 5A and 5B show how the radar scans shown in FIG. 4B may be mapped to locations on a heat-map;

FIG. 6A shows an example of a combined radar echo image;

FIG. 6B shows an example of closest coastline data;

FIG. 7 shows an example of a poor fit for a radar scan image to closest coastline data;

FIG. 8 shows the offset between the vessel location for which a poor fit was found and an updated vessel location estimate for which a best fit is obtained for the radar scan image to closest coastline data;

FIG. 9 shows how a vessel location can be monitored using radar data over a vessel course;

FIGS. 10 and 11 show examples of feature points in time-sequential radar scans;

FIG. 12 shows an example flowchart for a method for finding a speed and a course of a vessel according to the disclosed technology;

FIG. 13 shows schematically an example of a method of estimating the accuracy of the vessel position found using an embodiment of the method shown in FIG. 3 or FIG. 15;

FIG. 14 shows schematically an example of an uncertainty search area around an estimated vessel position found using the method of FIG. 3 or FIG. 15;

FIG. 15 shows schematically an example embodiment of the method of FIG. 3;

FIG. 16 shows schematically a system for implementing some embodiments of the disclosed technology; and

FIG. 17 shows schematically an example apparatus for implementing the system shown in FIG. 16.

### DETAILED DESCRIPTION

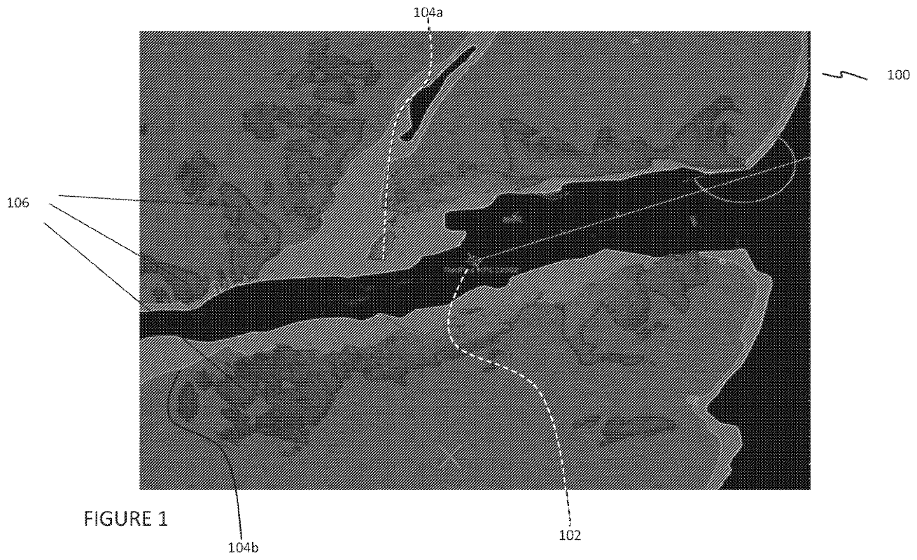

FIG. 1 shows an example composite image 100 comprising electronic navigation chart information overlaid with radar image data information as is known in the art. In FIG. 1, a vessel 102 is navigating a water body bordered by a various coastlines in the navigation chart, of which by way of example two are labelled in FIG. 1 as 104a, 104b. Coastline 104a is a closest coastline in the line of sight, LoS, to vessel 102. Coastline 104b is a coastline which is part of a landmass on one side of the water region where the vessel 102 is sailing. Also shown in FIG. 1 are a number of examples of radar features 106 superimposed on the electronic chart data.

The disclosed methods of locating a vessel using radar use radar-positioning to determine a vessel's location and allow automatic monitoring of the vessel's location using radar.

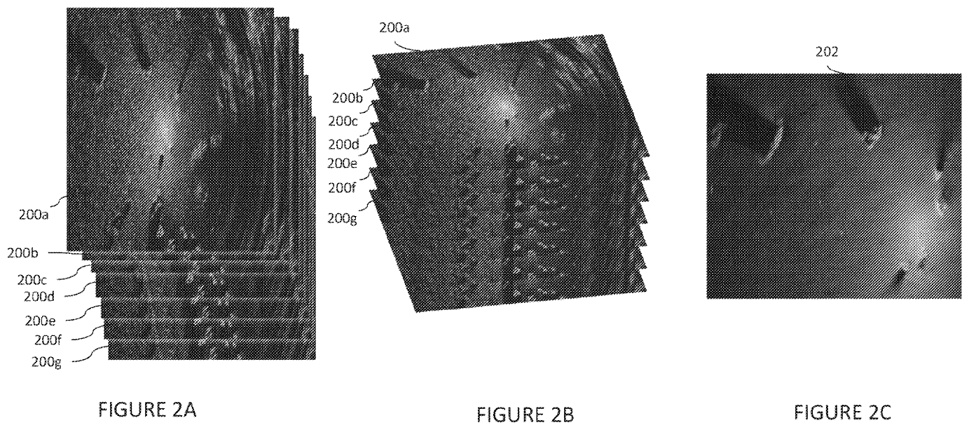

The methods start by acquiring a series of radar scans, for example radar scans 200a-200g shown in FIG. 2A which are shown schematically stacked over each other and off-set from each other to provide some indication of the movement of the vessel as the scans were acquired.

The acquired radar scans are then pre-processed. In some embodiments the pre-processing comprises motion compensation and moving object echo suppression. For example, motion compensation may be performed by adjusting each scan according to the vessel motion since the last scan. The vessel motion may be input automatically if determined using a vessel model such as the updated vessel model output 1620 in some embodiments. However the initial vessel position and motion may also be manually input.

Time-sequential radar scans are not limited to time-adjacent radar scans. If time-adjacent or near time-adjacent radar scan images are acquired for use by the methods of the disclosed technology, based on 1 to 2 seconds between each scan being acquired, the location of the vessel will usually not result in any significant change in the radar scan, allowing each scan to be adjusted by translating the scan images in the direction of the vessel course by an amount based on the vessel speed between each radar scan being used.

In some embodiments, non-time adjacent acquired radar scans are used, however, by only using, for example, every other scan, there is a loss of statistical confidence. As radar scan image processing algorithms are able to run real-time using every acquired radar scan 200, this leads to more confidence in the accuracy of the vessel position when determined using the radar scans. It is also possible in some embodiments to use a filter in a vessel model to weight each measurement of a vessel location obtained using a method of locating a vessel using radar 300 according to the disclosed technology. In this way, if there are sufficiently frequent location measurements, each measurement can be low-pass filtered by the vessel model to filter out measurements that are more noisy than the expected dynamics of the actual vessel.

FIG. 2B shows schematically an example of how motion-compensation may be performed on the radar scan images 200a-200g of FIG. 2A by vertically aligning the motion off-sets of the radar scans 200a-200b shown in the off-set stack formation of FIG. 2A.

The acquired radar scan image data may also be pre-processed to de-clutter the radar scan images by removing or suppressing data representing echoes that are not stationary, for example, by averaging the echo intensity from a number of the plurality of sampled radar scans 200a-200g at each individual location and to remove any other sources of noise using suitable techniques.

FIG. 2C shows an example of a combined radar scan image 202 which is obtained by combining the motion-compensated radar scan image data from each acquired scan 200a over a plurality of acquired radar scans 200a-200g. The acquired radar scans may also processed to remove noise and/or to enhance the SNR of stationary objects in the scan before or after the scans are motion compensated in some embodiments. By compensating for motion and combining, for example, by averaging the radar scan images, non-stationary echo clutter may be reduced. The combined radar scans may also be otherwise suitably de-noised to enhance the echo signals in the radar scan image from stationary objects.

In this way, a cleaned radar scan image 202 such as that shown in FIG. 2C is obtained by combining, for example, averaging the echo intensity from a plurality of acquired radar scans 200a-200g shown in FIG. 2A after they have been processed to compensate for the motion of the vessel. It will be apparent to anyone of ordinary skill in the art however that there are many other filtering and signal to noises enhancement or suppression techniques which may be performed to obtain a radar image 202 with less radar clutter than that shown in the individual radar scans 200a-200g. Some embodiments of the disclosed technology may use a weighted averaging technique to weight features which are very similar in the scans 200a-g higher than any features which are less similar.

The technique disclosed herein which combines a set of acquired radar scans 200a-200g obtained over an interval of time, for example every 15, 30, or 60 seconds or so, has the benefit of smearing out echo signals from moving objects as their location will still change from scan to scan even after the motion of the vessel 102 has been compensated for. This smearing results in a lower radial gradient in the radar echo scan signal strength (where the radial direction is centred on the vessel 102) than the radar echo signal strength or amplitude radial gradient generated by stationary objects generate in the radar echo scan.

Even if pre-processing the radar images does not remove all non-stationary object radar echoes, as the radial gradients of the radar echo signal amplitude for such non-stationary objects will be lower than the radial gradient of radar echo signal amplitudes for stationary objects, any remaining non-stationary objects are not likely to unduly affect the matching of the combined or filtered radar image scan to electronic chart features such as land and aids-to-navigation (ATON's).

The amount of time individually acquired radar scan echo signal images 200 are sampled for in order to generate a combined radar scan image 202 may be based on a predetermined time interval or number of scans 200. In some embodiments the amount of time may be configured by a user or set to a pre-set value.

Other techniques may be used to suppress echoes from non-stationary objects in other embodiments of the disclosed technology. For example, one or more averaging and filtering techniques which would be apparent to anyone of ordinary skill in the art may be used instead in some embodiments.

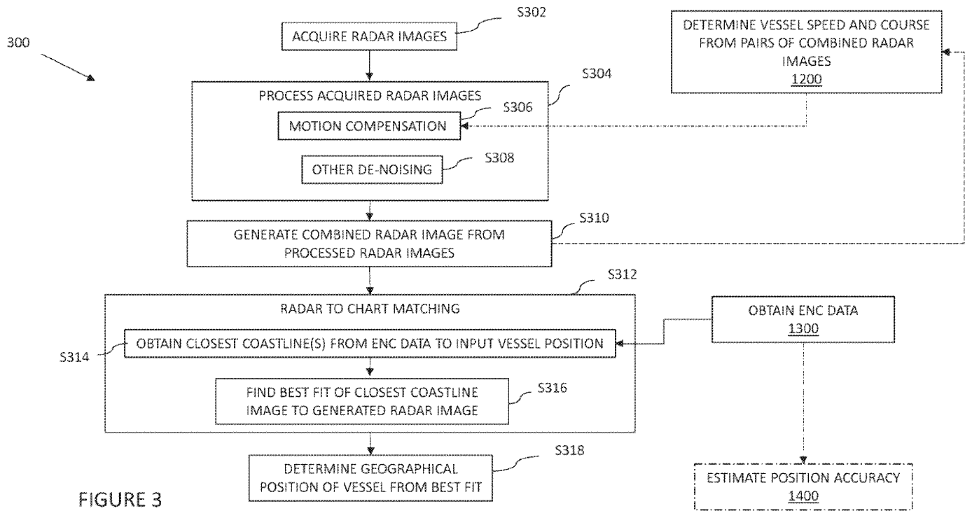

FIG. 3 shows an example of a computer-implemented method 300 for finding a geographic location of a vessel using radar according to the disclosed technology. Method 300 comprises acquiring at least two time-sequential radar scan images S302, processing the time-sequential radar scan images S304, for example, by at least compensating for motion of the vessel between radar scan images S306 and generating combined radar scans in S310 from the motion compensated scans in which radar echoes from non-stationary objects are suppressed. In some embodiments other processing steps may be performed such as de-noising the images to remove unwanted artefacts S308.

The combined radar scan 202 which is generated in S310 may comprise a cleaner radar scan image than any of the individual radar scans 200 that are acquired in S302 as radar signals from moving objects which are associated with smeared elements of the motion compensated radar scans will be suppressed in the combined radar scan 202.

The combined radar scan 202 may be obtained in S310 by, for example, combining using any suitable technique the processed radar scan images from S304. The method then performs matching, for a plurality of possible vessel positions, the combined radar scan image to one or more closest navigation chart coastline locations to each possible vessel position in S312, and the method further comprises determining the geographic location of the vessel based on the estimated vessel position resulting in the best match of the combined radar scan image to the one or more navigation chart coastlines locations S314.

In some embodiments, the closest coastline locations to each estimated vessel location are obtained by obtaining coastline chart data based on an initial vessel position at the start of an acquired radar scan and determining the locations of coastlines in line of sight of the initial vessel location from the coastline chart data. In some embodiments, coastlines are represented by polygons or points with their geographical position (for example, latitude, longitude). This allows the scale of the coastline data to not be relevant here.

The closest coastline locations can be retrieved by either scanning a rasterized chart, or by querying the coastline directly, if the application implementing the method 300 is hosted on an apparatus which has a suitable user interface and ENC chart application interface and if the ENC chart application is configured to accept queries from such an apparatus. For example, the coastline locations can be found by querying the ENC software using a suitable form of a “Grounding check” functionality query for an area and specifying a safety depth of 0 which is input to the ENC software application. A query of this type will return all coastlines within the queried area. It is also possible to use a software development kit, SDK, with some ENC applies to create a query specifically to obtain coastlines. The coastlines around a vessel position can be obtained by scanning all bearings and finding the first hit of a coastline (or other known object) using the ENC software chart information. This functionality may be provided by ray-tracing in a chart e.g. a chart provided by a chart SDK, or implemented as a post-processing step after querying all coastlines in some embodiments. These are the points will define the closest coastline. Land areas behind an island or peninsula for example will not be included as whether there is or is not a radar echo from such areas depends on the height of radar antenna mounted on the vessel in relation to height of the inland landmass on such islands and/or peninsulas.

The coastlines are represented by vectors comprising polygons or points with their exact geographical position (latitude, longitude). By using a vector-based system to project the coastlines onto the radar scan images, the relative scales and co-ordinate systems of the coastlines and the radar scan images are not required.

The coverage area for generating chart coastlines can be predetermined based on the known maximum radar range or be based on vessel location the distance of the vessel to shore and could be dynamically changed. In other words, to find the coastline data an initial or previously found vessel location can be input (or automatically updated based on the vessel model) to the ENC software application and the closest coastline data is then automatically retrieved for a given coverage area, in other words, up to the perimeter of the area within which land areas are being looked for in the electronic chart of a region around the vessel location.

The method 300 according to the disclosed technology matches the line of sight closest coastline locations for a number of possible vessel positions to the radar signal amplitudes which are strongest in the combined radar scan to find the best fit in S316. Based on the best fit found, the geographical position of the vessel can be determined in S318.

FIG. 3 also shows how optionally the ENC data may be used to obtain an estimate of the position accuracy of the geographical position of the vessel determined in S318.

FIG. 3 also show optionally the combined radar scans may be used to determine speed and course by performing a method 1200 which is described in more detail later below. By updating the vessel model input 1602 to the algorithm with the vessel speed and course using 1200, in the next iteration of method 300, for the next set of acquired radar images used to generate a combined radar scan for example, the motion compensation in S306 can use the updated vessel speed and course to compensate for motion between that set of acquired radar images.

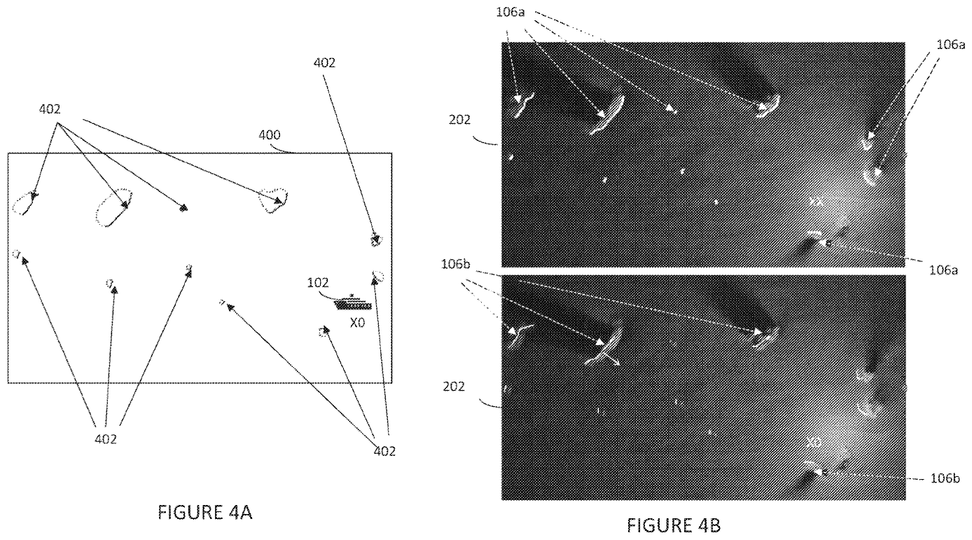

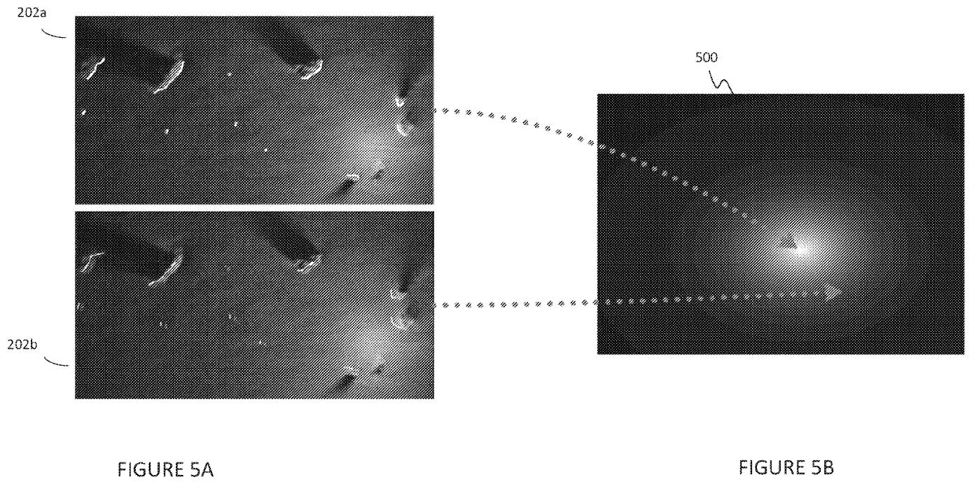

FIGS. 4A and 4B show schematically examples in which closest coast-line data is matched to a radar scan image. In FIG. 4A, based on an estimated initial location X0 of a vessel 102 on an electronic navigation chart 400, the closest coastlines 402 to the initial estimated vessel geographic position are found by determining one or more sections of coastline which are in line of sight of the vessel 102 based on the initial estimate of the ship's position X0.

The initial estimated position X0 may initially be provided by a user inputting the initial vessel estimate and/or by using another navigational vessel location system such as GNSS. If the method 300 is being used to monitor the vessel location using radar then a previous vessel location determined using a previous iteration of the method may be used to provide an estimated vessel location for the next iteration of the method 300.

In FIG. 4A, the solid coastlines 402 represent the coastlines facing the location X0 of vessel 102. The dotted coastlines are not used by the radar positioning method 200 due to the radar shadow which naturally falls behind the solid line-of-sight coastlines 402.

FIG. 4B shows two combined radar scan images 202 generated when the vessel is at location XX. The bottom image shows an image of the closest coastline data (shown as white solid lines for contrast) overlaid with the combined radar chart image 202 based on an estimated vessel location X0. In this case, there is not a good fit as the vessel 102 was at location XX and the radar chart is being fitted to coastline data generated based on the vessel being instead at a location X0. If the closest coastline data is obtained for a different estimated initial location, XX however, then there is a much better fit as the top image shows.

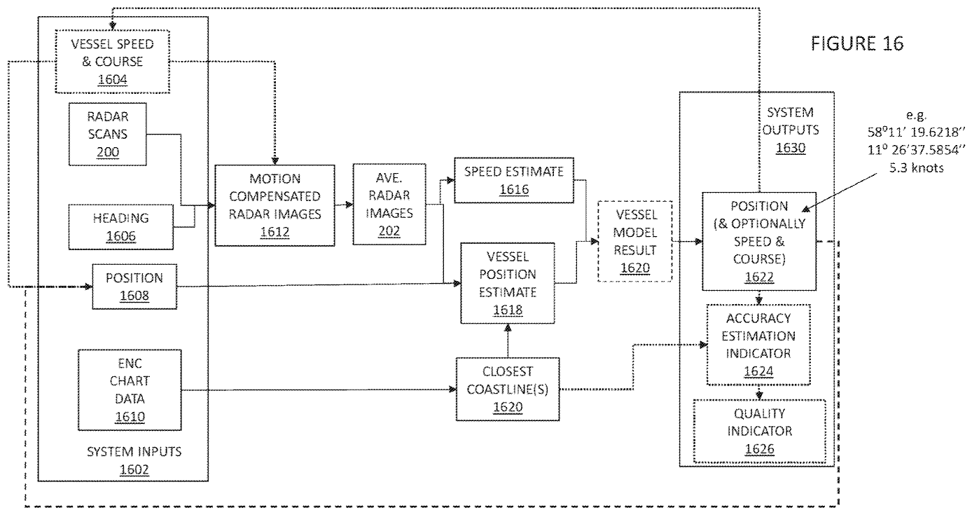

The embodiments of the method are equivalent to sliding and/or translating the closest coastline data over a combined radar image 202 for a plurality of possible vessel location within a maximum search area for estimated vessel locations. To finding the best fit, each coastline image should have the same scale as the radar scan image and the coastline chart-based images and radar scan images may also need to be rotated to align compass bearings. This can be achieved by providing heading information as an initial input to the method 300 along with the acquired radar scans (see also FIG. 16 below for more detail on examples of system inputs to implement at least one embodiment of the disclosed technology).

The maximum search area may be user-defined in some embodiments but it may also have a default and/or pre-set value. A brute-force grid search can be used in some embodiments however, in some embodiments instead an optimization method such as SGD (steepest gradient descent) may be used instead to explore which estimated vessel location within the search area results in the best match between the combined radar scan image and the closest coastline image. In some embodiments, the SGD method determines for each estimated vessel location a sum of all radial gradients of the combined radar scan signal before the closest coastline geometry is obtained. Here the radial gradient is the change in the radar scan signal amplitude seen along a radial direction or bearing from the vessel. A sudden increase in in the radar echo signal amplitude along the radial dimension, indicates the radar pulse has hit an object other than water.

FIG. 5A replicates the features in FIG. 4B and shows schematically how the two estimated vessel locations of FIG. 4B can be represented in a heat map such as the heat map of FIG. 5B when method 300 searches for the estimate position of vessel 102 using a radial gradient descent method. In FIG. 5B, the heat-map 500 shows the sum of the radial gradients of the radar echo signal's amplitude at different offsets of the electronic chart data closest coastline image estimated vessel location to the electronic chart data based on the actual vessel position along a north-south and east-west direction over all bearings 0 to 360 around the vessel.

The peak amplitude in the heat-map of FIG. 5B is generated when the closest coastline data is used for an estimated vessel location which is where the vessel is actually located, as this results in the radar signals changing amplitude most strongly when land is reached. In other words, the echo signals have the steepest gradient as they reach land because of the flat water surface, and rise due to the shape of the coastline rising. A cliff will generate a larger gradient accordingly than a shallow beach. The leading edge of the radar gradient is used which is the gradient going from a low echo intensity at water surface, compared to a high echo intensity when hitting land. By checking over all radial directions, in other words, bearings, from the vessel 102 and by summing the radial gradients over all bearings 0 to 360, a heat-map can be generated for each possible vessel position. The actual vessel location will be located at the peak in the heat map which is the vessel location from which the sum of the radial gradients, in other words, the changes, in the radar echo signal amplitude changes most overall 0 to 360 bearings around the vessel. The intensity of the heat map peak will at least partially be affected by the amount of coastline which has been used to generate the estimated vessel location and the radar signal sensitivity. A brighter heat map peak may indicate more coastline and/or that the radar signal intensity rises more rapidly when land was reached.

In some embodiments of method 300 accordingly, the suppression of signals comprising radar echoes from moving objects S308 results in a smeared representation of the moving object in the combined radar scan having a lower radial gradient along a line of sight with the vessel.

This is useful as it smears out the signal gradients for non-stationary (for example, moving) objects, automatically leads to lower radial gradient radar echo signals. This results in radar scan echo signals returned from non-stationary objects being given less weight when searching for the vessel's geographic position than any higher gradient radar echo signals generated by the radar scan signal being returned from stationary objects such as land and aids-to-navigation (AToNs).

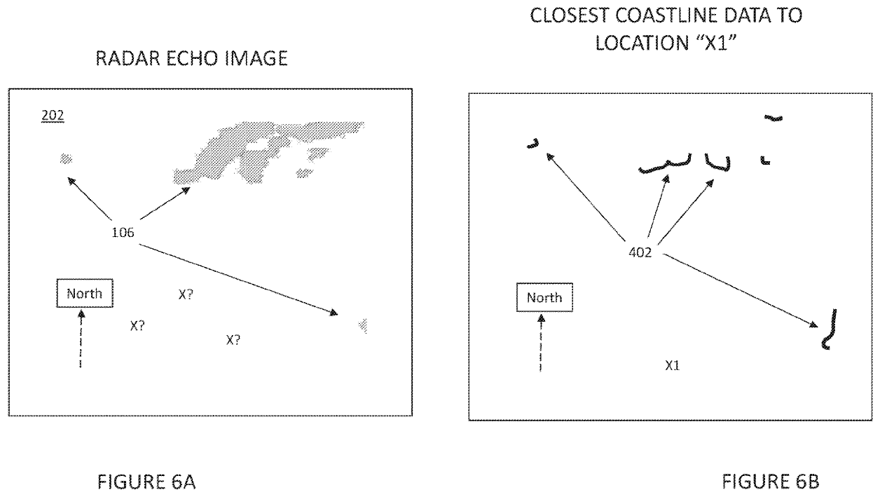

To demonstrate in more detail how the geographic location of the vessel can be obtained using an example embodiment of method 300 in which a grid search is performed to find the estimated location of vessel 102, FIG. 6A shows an example combined radar scan image and also includes an indication of which way is north. The north direction can be found using a compass reading or using any other suitable technique known in the art. FIG. 6B shows an example image of coast-line data found for an estimated position “X” of a vessel 102. There is no need to generate an actual image of coastline data for use in the disclosed embodiments. Instead, a vector representing the locations of features (e.g. in terms of their latitude and longitude) in the coastline data obtained from the electronic chart information is projected onto the radar scan image features to find the best match.

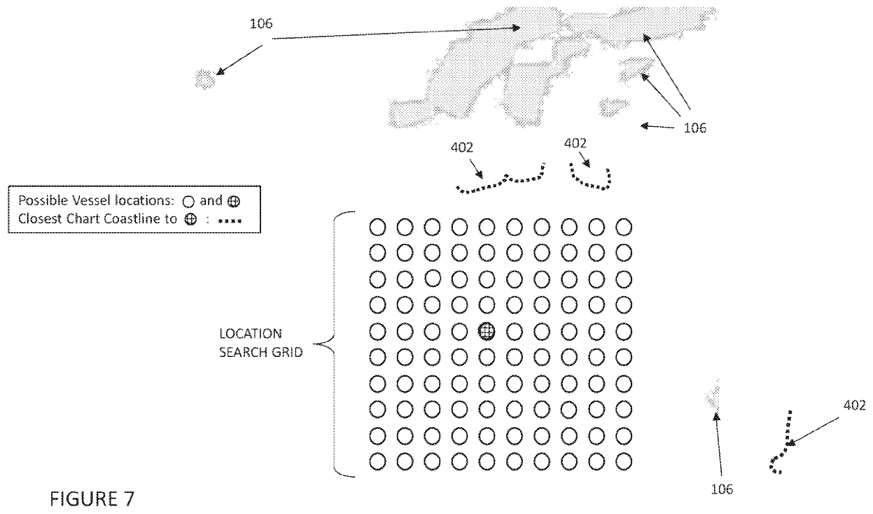

FIG. 7 shows schematically for an example 10×10 search-grid comprising 100 possible vessel locations, how at an possible vessel location shown by the hatched circle in FIG. 7 the closest coastline electronic chart data (for example, that of FIG. 6B) shown by the dotted broken lines does not have a good fit to the radar features 106 shown in the combined radar scan image (for example, the radar scan image of FIG. 6A). In FIG. 7, the actual vessel location in the search grid is also shown by a solid black circle. The concentric circles illustrate the radar scan signal as it would be emanating from the possible hatched circle vessel location in the search grid whereas in reality the radar scan image is emanating from the vessel at the possible black circle vessel location.

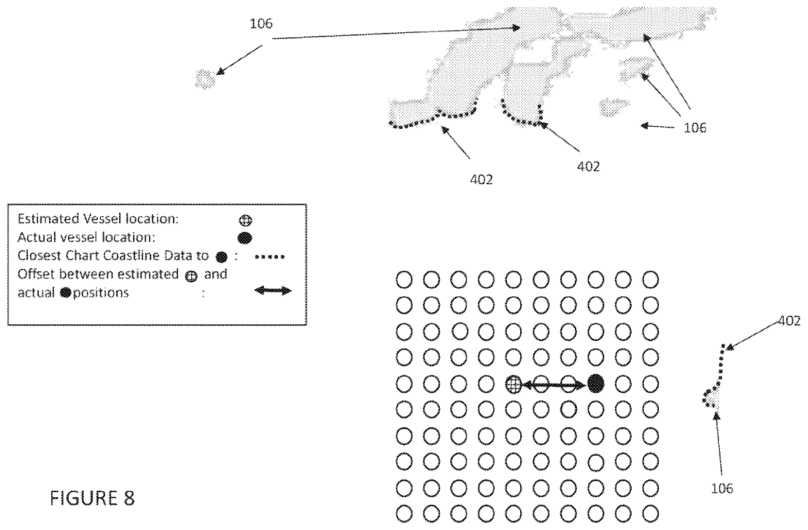

FIG. 8 shows schematically for another possible vessel location in the search grid of FIG. 7, in this case the best estimated vessel location shown by the black circle in the search grid, by sliding the coastline data image over a radar scan image, a much better fit between the radar features and the closest coastline data can be found. In FIG. 8, the closest coastline data was generated for the possible vessel location shown with the black dot in the 10×10 search grid and in this case that possible vessel location provided the best fit of all the possible vessel locations in the search grid and is taken as the actual vessel location.

FIG. 8 also shows schematically for an example where the possible vessel location shown by the hatched circle in the search grid may be taken as the initial vessel location and updated with an offset 900 to the actual vessel location after performing the method 300. The updated estimated vessel position, shown the black dot in the search grid at which a best fit was found when matching the closest coastline chart data to the radar echo scan image, may then be taken as the starting or initial vessel location for a subsequent iteration of method 300 for the next combined radar scan 202.

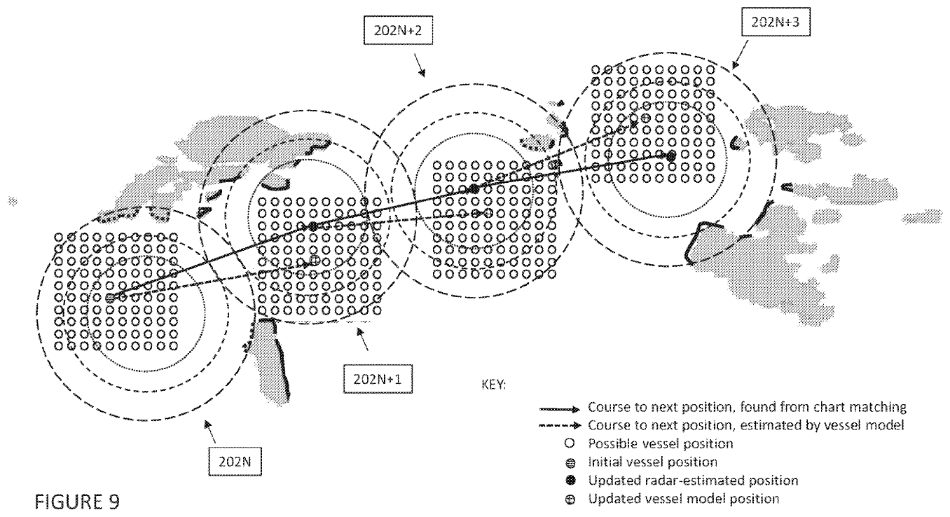

FIG. 9 shows how by repeating the method 300 for a plurality of combined radar scans 202N, 202N+1, 202N+2, 202N+3 the locations of vessel 102 as estimated using the radar positioning of method 300 (shown as the black dot in each search grid of FIG. 9) may be continued to be monitored without reliance on other positioning techniques. A similar monitoring scheme may be used with a radial descent gradient technique shown schematically in FIG. 5B to locate the vessel 102 in other embodiments of method 300.

As shown in FIG. 9, a plurality of time-sequential (although not necessary time-adjacent) combined radar scans 202N, 202N+1, 202N+2, 202N+3 are obtained, each representing a motion-compensated non-stationary object echo suppressed radar scan 202 generated from a plurality of acquired radar scans such as scans 200a to 200g shown in FIG. 2A.

FIG. 9 shows by way of example a plurality of 10×10 search grids each comprising 100 possible vessel locations which are searched to find the actual vessel location for each combined radar scan N . . . N+3. By matching the combined radar scan image to the closest coastline image obtained for each of the 100 possible vessel locations in each search grid by sliding around the closest coastline data images and/or radar scan images until the best match is found for the overlaid images, it is possible to find which of the 100 possible vessel locations in a 10×10 search grid provides the best fit and to then take that location as the actual geographic location of the vessel at various points in time along the vessel voyage.

As shown in FIG. 9, for scan N the best fit to the coastline data shown by the dashed line is found at the indicated location where both arrows indicating the vessel course according to the vessel model (the dashed arrow) and the vessel course according to the chart-matching method (the solid line arrow) originate from. By way of example only, each combined radar scan image 200 may be generated in some embodiments by processing a plurality of time-adjacent acquired radar scans images 200, for example 10 acquired scans 200 may be combined at a time.

By way of example only a combined radar scan image 202 may be generated in some embodiments by processing non-time-adjacent acquired radar scans images, for example, radar scan images 1, 3, 5, 7, 9 for example, instead of each time-adjacent radar scan images, say for example scans 1 to 10. In some embodiments, the number of acquired radar scans 200 or the duration over which acquired radar scans 200 are combined to form a combined radar scan image 202 is determined dynamically based on the environment of the vessel. In this way if one or more or all of the environment around the vessel changes rapidly, the vessel is moving rapidly, and the time interval between radar scans is longer, fewer acquired radar scan images 200 may be used to form combined radar scan image 202.

Each of the 202N . . . 202N+3 combined radar echo signal scans shown in FIG. 9 is generated by processing a plurality of acquired radar scans 200 at least so the vessel motion between acquired radar scans can be compensated for and also so noise and/or echoes from moving objects in the acquired radar scans 202N . . . N+3 can be suppressed or removed.

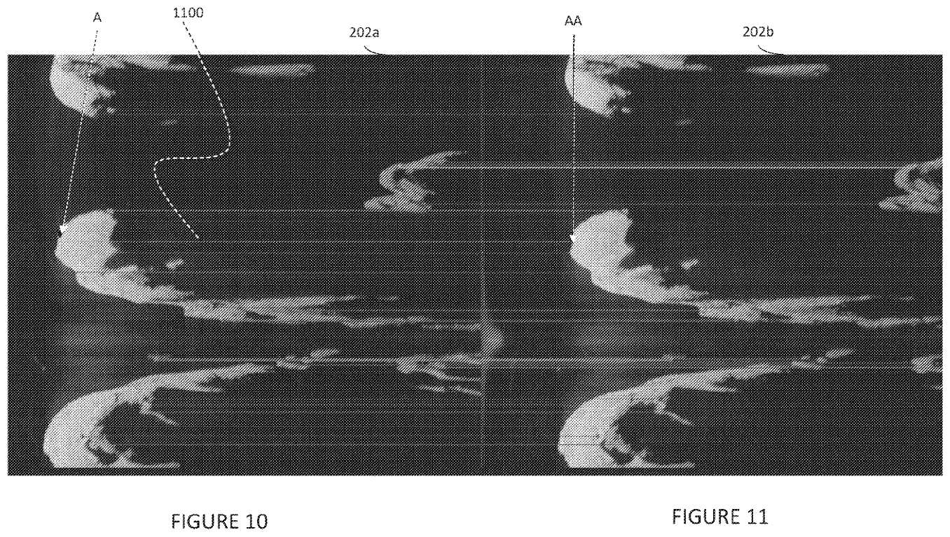

As the vessel moves from left to right in FIG. 10, the vessel location found for scan 202N can be updated for the next combined radar scan image 202N+1 using a vessel model comprising at least a course and speed of the vessel, over the time-interval between the combined radar scan 200N and the combined radar scan 200N+1.

Once a new combined radar scan 202N+1 has been generated from a plurality of acquired radar scans 200, a new search grid is generated to update the vessel location determined from the vessel model with an estimated vessel position found using method 300. The new location in the search grid to be used by the method 300 for combined scan 200N+1 is shown by the hatched circle in that search grid and is linked to the vessel location in the search grid of scan 202N by a solid arrow.

The chart coastline data for the region around the vessel, also referred to herein as the coastline chart coverage area, is then found based, for example, on the rough position found using the planned vessel course and speed from the previous vessel location estimated by method 300.

The closest coastline within this chart coverage area is then found for each possible location of the vessel 102 in the search grid for combined radar scan image 202N_1. By then checking which of the possible 100 vessel positions in the 10×10 search grid shown in FIG. 10 result in the best fit for an image of the closest coastline chart location data to the features in the combined radar scan image 202N+1, an estimate of the vessel location in the search grid 202N+1 can be found. Alternatively, an estimate of the vessel location can be found using the strongest radial gradient descent technique shown in FIG. 5A by updating the heat-map for the new search grid. The resulting updated estimate of the vessel location in the search grid for combined radar scan image 202N+1 can then be repeated for scan 202N+2 and then for scan 202N+3 and so on, allowing the vessel's location to be estimated using the radar to closest coastline chart data. The technique is more reliable if there is more coastline data for the radar scan images to be fitted to, and so has limitations, but as long as there is some coastline data or other stationary objects shown in the electronic chart data which will generate a sufficiently strong radar echo signal, method 300 can be used independently of other techniques to monitor vessel location, as it is also possible to determine a vessel's course and speed using the method 300.

To monitor the vessel over time, Some embodiments of method 300 further comprise generating an estimate of the vessel course (as shown by the solid arrows in FIG. 9) and vessel speed. This estimate can also be used to perform the motion compensation S306 of the processing S304 in method 300. By compensating for the motion of the vessel it allows echoes from any non-stationary object which are detected by the radar scan to be suppressed in S308. Accordingly, in order to reduce the reliance on estimates of vessel course and speed generated using GNSS or another technique, in some embodiments of the method 300, feature extraction followed by feature point matching is used to identify features in time-adjacent or near adjacent acquired radar scans. Other methods which may be used in addition or instead in other embodiments of the disclosed method 300 include image correlation and optical flow but any suitable techniques may be used which would be apparent to someone of ordinary skill in the art.

FIGS. 10 and 11 show an example where a pair of combined radar scans 202a, 202b are used to determine a vessel course and speed. FIG. 10 shows how a feature point A in an acquired radar scan 200a has a corresponding feature point AA shown in a subsequently acquired radar scan 200b shown in FIG. 11. FIGS. 10 and 11 show a plurality of pairs of corresponding features points which are linked by horizontal or horizontal streaks, including a horizontal stream 1100 between A and AA. The pair of scans 202a,202b are motion compensated images and finding the vessel speed and course of the vessel model (see 1620 in FIG. 16) may comprise a feedback loop that will self-adjust in some embodiments of the disclosed technology. Turning briefly now to FIG. 16, it is also possible to provide as an initial input 1602 to the system 1600 which implements the methods disclosed herein, an vessel model comprising an initialised vessel position (which may be manually input), in some embodiments, the vessel model input 1602 to the system may also be initialised with an optional known speed and course to perform the motion compensation shown in 1612 (see also S306 in FIG. 3).

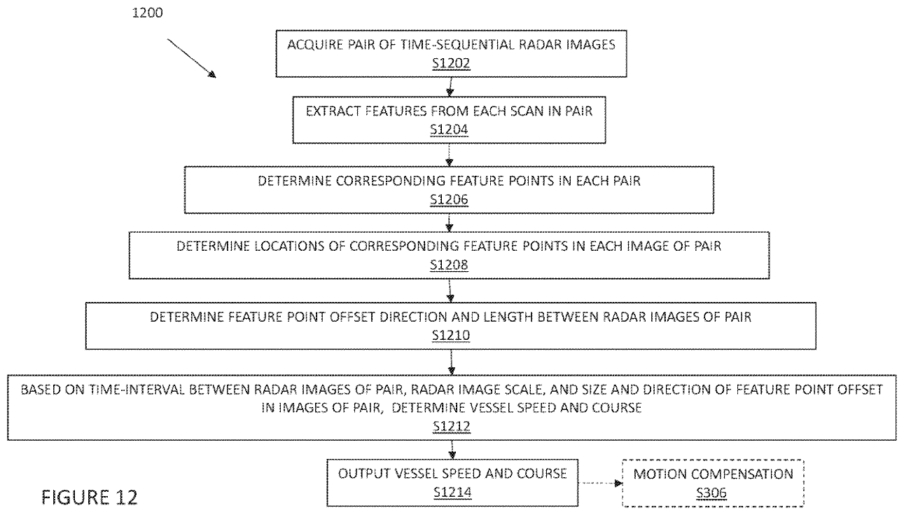

FIG. 12 shows in more detail an embodiment of a method 1200 to find a speed and course of the vessel 102 which may be used in some embodiments method 300 to compensate for motion between adjacent radar scans 200a, 200b such as those shown in FIGS. 11A and 11B respectively. Method 1200 as shown in FIG. 12 acquires pairs of time-sequential radar scans 200a,b in S1202, which may be a pair of time adjacent or other reasonably closely time-sequential radar scans separated by an interval of time T. For example, radar scans 200a and 200b shown in FIGS. 10 and 11 may form a pair of radar scans.

In the method 1200 show in FIG. 12, features are first extracted from each radar scan of the pair of radar scans being processed in S1204. Next corresponding feature points in each of the radar scans is determined in S1206, and the locations of the corresponding feature points is determined in S1208 for a plurality of feature points in each radar image of the pair. The direction of the offset and the direction of the distance offset can then be determined. The streaks linking scan images 200a,b in FIGS. 10 and 11 between feature points to some extent reflects the offset distance and direction, although the distance and off-set between the scan image locations has not being taken into account in FIGS. 10 and 11.

The combine offset distance and direction is determined by method 1200 in S1210. Providing the bearing of the vessel 102 and the radar bearing are known, the direction of the offset can be determined as a vessel course, and as long as the scale of the radar images is known which allows the actual distance between matching feature points to be determined and the length of time between the radar images being generated is known, the speed of the vessel can be determined. The result can be output in S1214 and may be used to perform motion compensation S306 in some embodiment of the method 300 (see motion compensation 300 in FIG. 3).

Some embodiments of method 300 also estimate the accuracy of the geographic position of the vessel determined using method 300.

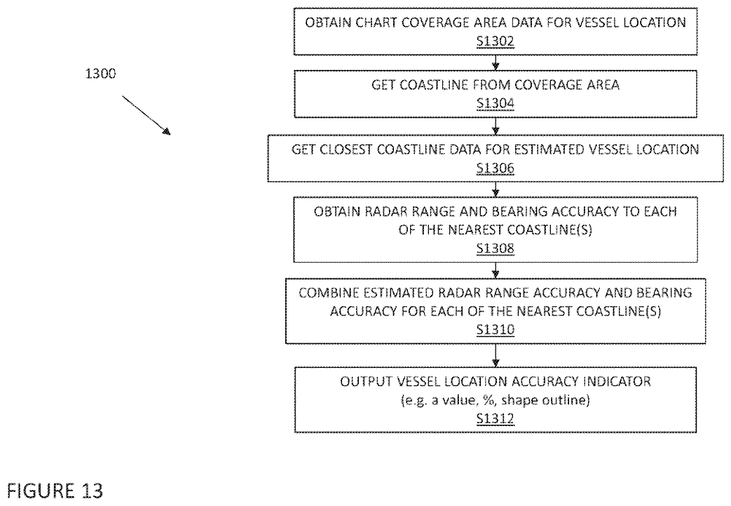

FIG. 13 shows an example method 1300 for estimating the accuracy of the radar positioned location of a vessel found using the method 300.

Method 1300 comprises obtaining the chart coverage area data around the estimated vessel location S1302, then obtaining coastline data from the chart overage area in S1304. Next, the closed coastline data is obtained for the estimated vessel location S1306, for example, the closest coastlines over all bearings 0 to 360 around that possible vessel position may be found.

The method then obtains the radar range accuracy and bearing accuracy to each of the nearest coastline(s) in S1308. For example, if the radar range resolution is +/3 m at 100 miles from shore, and +/−6 m 200 miles from shore, then the vehicle position based on a radar match to a coastline 100 miles from shore being accurate is limited by the radar resolution alone to being within at least +/−3 m whereas if the closest coastline is 200 miles from shore, the vessel position determined using the radar system cannot be better than +/−6 meters due to the limitations in the radar scanner resolution. These resolution limitations are compounded by any limitations in the bearing accuracy.

The estimated radar range accuracy and bearing accuracy are combined for all possible 0 to 360 bearings around the vessel location in S1310 and the result is output as a vessel location accuracy indicator in S1312. The output may be an audible alert or message, a displayed alert or message, and make take the form of a value, a percentage, or a shape outline superimposed on the combined radar scan image.

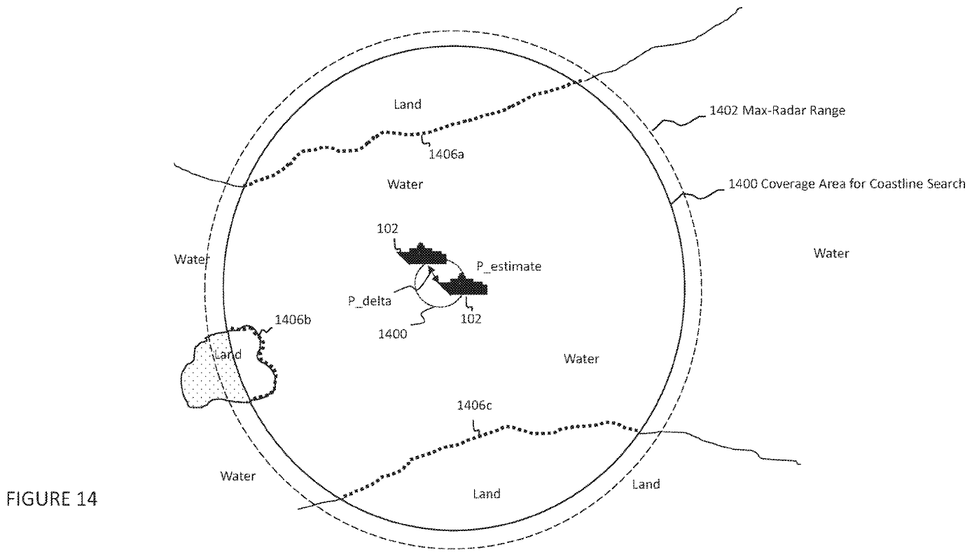

FIG. 14 shows schematically for an estimated vessel location P_estimate which was found by the method 300 to have the best fit of its radar scan image to the closest coastline data around it, which also shows, based on the estimated accuracy found by method 1300 found from analyzing coastlines in the “coverage area”, how a suitable search area for doing the vessel positioning may be determined.

In FIG. 14, the search area 1400 is found from the coastlines in the coverage area which provide an estimate of how accurate the radar scan is likely to be at the distance from the vessel where the closest coastlines are located. In FIG. 14, an estimated vessel location is P_estimate, and another estimated vessel position is offset from P_estimate by P_delta which as shown in FIG. 14 as within a circle defining the location of the search grid 1400.

Also show in FIG. 14 is an example of a coverage area 1402 used for the coastline search for the closest coastlines and an example of a maximum radar scan range 1404 from the vessel 102. The closest coastlines are shown as 1406a,b,c. Closest coastline 1406b is on an island and the land region which is in the radar shadow from P_estimate has a light-dot pattern-fill to distinguish it from the hand region which is not in radar shadow.

In some embodiments, the uncertainty search grid may have a smaller grid size than the grid size used in method 300, in which case it is possible to find a more accurate estimated vessel location using the accuracy method.

The radar-positioned location accuracy of method 300 depends on the amount surrounding coastline. For example, if there is land in all directions at short ranges, the accuracy is increased. In contrast, land masses in only one direction and far away decreases the accuracy of the automatically determined radar-position. By combining the radar scan determined range and bearing resolution to features on the coastline, with the chart coverage area, a probability of a position being provided by method 300 at a certain accuracy may also be determined.

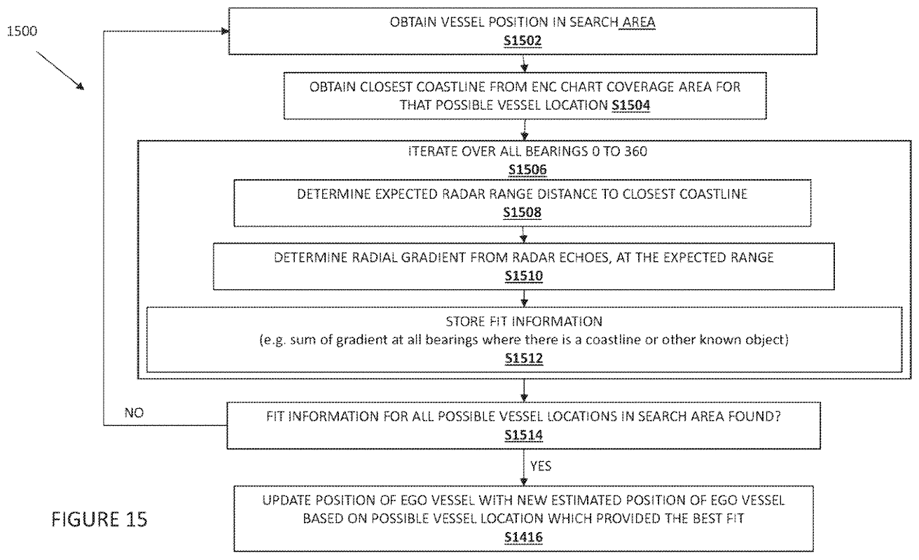

FIG. 15 shows schematically an example of a method 1500 comprising an embodiment of method 300 in which a steepest radial gradient technique is used to determine a vessel location by matching radar scan echo image data to closest coastline(s) image data within a search area. As shown in FIG. 15, method 1500 obtains a vessel position in S1502, which may be an initial position input by a user or other navigational system, or obtained by performing a previous iteration of method 1500 or 300. Next the closest coastline data for the ENC coverage area is obtained for that vessel position in S1504. Then for all bearings 0 to 360 in S1506, the expected radar range to the closest coastline for the position found in S1502 is found in S1508, and the radial gradient from radar echoes at the expected range for that closest coastline data is determined in S1510. The sum of the radial gradient at all bearings where there is a coastline or other known chart object is then found and stored as fit information in S1512. If fit information has been stored for all possible vessel locations in the search area S1514, the best fit is determined by finding the vessel location associated with fit information indicating the highest gradient, and the position of the vessel is updated in S1516 if not, then the method returns to steps S1502 to find another possible vessel location in the search area and steps S1504 to S1514 are repeated for that possible vessel location.

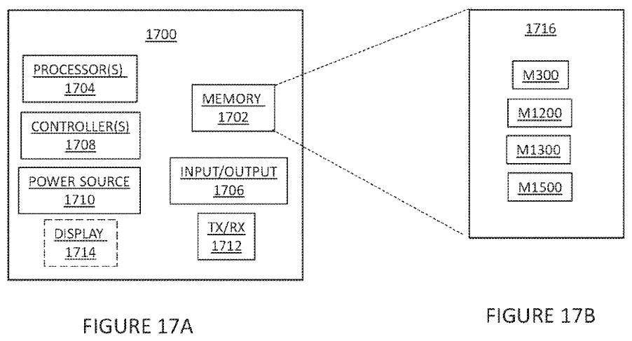

FIG. 16 shows schematically a system 1600 which comprise an apparatus such as apparatus 1700 of FIG. 17 described below which has been configured to implement an embodiment of the disclosed technology using, for example, appropriate methods 300, 1200, 1300, 1500.

FIG. 16 shows system inputs 1602 comprising a vessel speed and course 1604, a plurality of acquired radar scans 200, a vessel heading 1606 which are used to generate a plurality of motion compensated radar images 1612 and which are then processed to genera combined radar scan images 202 from which, together with the closest coastline and chart object data shown as closest coastlines 1628 obtained from the ENC chart coverage data 1610, the system generates a vessel speed estimate 1616, for example, and a vessel position estimate 1618. The results may be filtered over time, for example, a Kalman filter may be applied or another filtering technique used to improve the accuracy of the resulting position estimates 1622 in some embodiments which form the system outputs 1630. The system outputs 1630 may also include an optional an accuracy estimation indicator 1624 and/or a position quality or confidence indicator 1626 which are also be generated in some embodiments of the system 1600 using the closest coastline data 1628 obtained from the ENC coverage area input 1610. In some embodiments of the system 1600, the system outputs 1630 include the vessel speed and course 1604 which is used in subsequent iterations of the method 1500, 300 to perform motion compensation on the acquired radar scans 200. The ship speed and coarse may be estimated from radar scans using any suitable image feature extraction technique known in the art, for example, a suitable technique may be disclosed in Y. Linder and V. Taranukha, “Deep Learning Method for Extracting Information from Radar Images of Marine Objects,” 2022 IEEE 4th International Conference on Advanced Trends in Information Theory (ATIT), Kyiv, Ukraine, 2022, pp. 381-384, doi: 10.1109/ATIT58178.2022.10024204, may be used. Other examples include the libraries ORB, BRISK, FAST, KAZ, MINEIGEN, such as are well known in the art.

Some embodiments of the system 1600 comprises apparatus 1700 shown in FIG. 17.

The apparatus 1700 may comprises a standard computer apparatus or an apparatus which is specifically designed to implement the methods. The apparatus 1700 may comprise a stand-alone apparatus or be integrated into a bridge deck with other navigational equipment.

FIG. 17A shows schematically an example of an apparatus 1700 according to some embodiments of the disclosed technology which may be used to implement an example embodiment of the disclosed technology. Apparatus 1700 may comprise a generic computer adapted to run software such as software or computer code 1716 shown in FIG. 17B in some embodiments which is suitably stored in memory 1702 of the apparatus.

Example embodiments of apparatus 1700 may comprise one or more processors or processing circuitry 1704 and/or one or more controller(s) and/or control circuitry 1708. The computer code 1716 may comprises example embodiments of the above mentioned pseudocode which can be loaded from memory and executed by the one or more processor(s) or processing circuitry 1704 to implement an example embodiment of any of the above described methods 300, 1200, 1300 or 1500 for example.

As shown in FIG. 17A, the apparatus 1700 also comprises a suitable power source 1710, although in some embodiments, if the apparatus is built into an equipment console, the power source may be provided via the power source to the equipment console. A back up power supply such as a battery may also be provided in some embodiments. As shown in the example embodiment of apparatus 1700 shown in FIG. 12A, a suitable data input and output interface 1706 such as one or more data ports is also provided to receive, for example, electronic chart information data 1610 which may also be stored in memory 1202 in some embodiments and/or the apparatus 1700 may comprise a user interface configured to receive user input initial position information and/or compass information from an electronic source or manually input heading information. The data I/O 1706 may be an air interface for wireless communications in some embodiments where the apparatus 1700 also includes a suitable wireless receiver/transmitter and antenna equipment shown as TX/RX 1712 in FIG. 12A.

FIG. 17B shows the computer code 1716. In some embodiments, and as illustrated schematically in FIG. 17B, the computer code may comprise a plurality of different modules or functions which can be called to implement embodiments of one or more or all of methods 300, 1200, 1300 and 1500 according to the disclosed technology. For example, computer code represented by one or more or all of modules M300, M1200, M1300, and M1500 may be stored in memory 1702. When each method module code is loaded from memory 1702, it causes apparatus to perform respectively an embodiment of the corresponding method 300, 1200, 1300 and 1500, which allows the apparatus 1700 to at least partially implement an example embodiment of the system 1500 shown in FIG. 15.

Some embodiments of the disclosed technology comprise a computer program product which comprises computer program code which, when loaded from memory and executed by one or processor(s) or processing circuitry of an apparatus, cause the apparatus to implement a method according to one or more of the above described method embodiments.

In some embodiments, the computer program code may comprise one or more modules which comprise functions which can be represented by the following pseudo-code example for the methods of radar positioning a vessel and estimating the resulting accuracy of the radar-derived vessel position:

```
  Function Get Speed and course from radar scans:
    Extract features from first scan
    Extract features from second scan
      Match features and get offset as a 2D vector
      Return speed and course
  End function
  Function Radar to chart matcher
  Get coastline from chart database
    For each position in search area:
      For each bearing 0 to 360
        Find distance to closest coastline
        IF coastline found
        Calculate radar echo radial gradient at the distance
        Sum and store result
          End
        Store current position along with sum of gradients
      End
      Best fit where largest gradient is found.
  End function
  Function Estimate accuracy
      Get coastline from chart database
      For each bearing 0 to 360
        Find distance to closest coastline
        IF coastline found
          Calculate accuracy for example using a multi-variate technique
          Store accuracy and/or confidence
        End
      End
      return accuracy at specified confidence
  End Function
  # Main Method below:
  Get initial position from user or reference system
  Initialise vessel model with position and possibly speed and course
  WHILE App is running
    Get two last pre-processed radar scans
      CALL Get Speed and course from radar scans
      From Vessel model, get estimated position (extrapolated or predicted to current time)
      CALL Radar to chart matcher with last radar scan and estimated position
      CALL Estimate accuracy
      Update vessel model with new speed, course and position estimate
Report position, speed and course
```

In some embodiments of the code, a suitable multi-variate method may be used to determine a degree of confidence in the vessel location. From the coastline locations relative to the vessel, the expected accuracy is calculated in all directions. A suitable multi-variate method may be used to achieve this, combining accuracy from each individual direction and radar range. If the confidence is determined to be above a threshold, then a quality assessment is performed, which may also form an output of the system 1600 shown in FIG. 1600.

It will be obvious to those of ordinary skill in the art, however, that the invention is not limited to the specific code module structure for the pseudo code example implementations shown in FIG. 17B and described above.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise.

As used herein the term “and/or” includes any and all combinations of one or more of the associated listed items and may be abbreviated as “/”.

It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for finding a geographic location of a vessel using radar, the method comprising:
acquiring at least two time-sequential radar scan images;
processing the radar images at least by compensating for motion of the vessel between radar scan images and suppressing radar echoes from moving objects;
deriving a combined radar scan image from the processed radar scan images;
inputting a vessel position;
matching, for a plurality of estimated vessel positions in a search area including the input vessel position, the combined radar scan image to one or more closest navigation chart coastline locations to each of the plurality of estimated vessel positions, and
determining the geographic location of the vessel based on the estimated vessel position resulting in the best match of the combined radar scan image to the one or more navigation chart coastlines locations.

2. The method of claim 1, wherein the closest coastline locations to each estimated vessel location are obtained by:
obtaining coastline chart data based on an initial possible vessel position;
determining the locations of coastlines in line of sight of each possible vessel location in the search area from the obtained coastline chart data.

3. The method of claim 2, wherein in each iteration of method, the matching comprises projecting the electronic chart closest coastline location data onto the combined radar scan to find the best fit for all possible vessel locations.

4. The method of claim 3, wherein the best fit is found by finding the possible vessel location in the search area having the highest sum of radial gradients in the amplitude radar echo image data at the expected location of the closest coastline data from that possible vessel position.

5. The method of claim 1, wherein the processing of the radar images results in a smeared representation of one or more or all of moving objects, clutter, noise and interference in the combined radar scan which has a lower radial gradient of echo signal intensity along a line of sight from the vessel.

6. The method of claim 1, wherein the processing further includes one or both of enhancing the signal to noise of the radar echo signal in each motion compensated acquired scan or filtering noise from each motion compensated acquired scan.

7. The method of claim 1, wherein, the closest coastline data also comprises other stationary objects shown in the electronic chart data from which a radar scan echo may be generated.

8. The method of claim 1, further comprising:
generating vessel speed and course information;
using the generated vessel speed and course information to input the estimate starting vessel position in subsequent iterations of the method of any one of the previous claims.

9. The method of claim 1, further comprising:
generating vessel speed and course information; and
using the generated vessel speed and course information to perform motion compensation in subsequent iterations of the method of any one of the previous claims.

10. The method of claim 1, further comprising generating an estimate of the accuracy of the estimated vessel location, the method comprising:
obtaining chart coverage area data for the estimated vessel location;
determining coastline data from the coverage area;
determining closest coastline data for the estimated vessel location;
obtaining at least one of a radar range accuracy and a bearing accuracy to the locations of the nearest coastlines;
combining, over all bearings, the estimated radar range accuracy and bearing accuracy for each of the nearest coastline(s); and
outputting a vessel location accuracy indicator.

11. A method of estimating the accuracy of vessel location found using a method according to claim 1, the method of accuracy estimation comprising:
obtaining chart coverage area data for the estimated vessel location;
determining coastline data from the coverage area;
determining closest coastline data for the estimated vessel location;
obtaining at least one of a radar range accuracy and a bearing accuracy to the locations of the nearest coastlines;
combining, over all bearings, the estimated radar range accuracy and bearing accuracy for each of the nearest coastline(s); and
outputting a vessel location accuracy indicator.

12. The method of claim 11 wherein the vessel location accuracy indicator comprises one or more of:
an audible or visual value metric for accuracy;
an visual shape outline which is overlaid on an image of a combined radar scan.

13. An apparatus comprising at least:
memory;
one or more processors or processing circuitry; and
computer code;
wherein the computer code is stored in the memory and when loaded and executed by the one or more processor(s) or processing circuitry causes the apparatus to implement a method according to claim 1.

14. A computer-readable media comprising computer code, wherein the computer code is configured, when loaded from memory and executed by one or more processor(s) or processing circuitry, to cause an apparatus to implement a method according to claim 1.

15. A vessel with an unmanned bridge including an apparatus (1700) configured to implement a method according to claim 1.

16. The vessel of claim 15, wherein the vessel comprises an autonomous vessel or a remotely controlled vessel.
